(19) United States
(12) Patent Application Publication
(10) Pub. No.: US 2017/0052561 A1
(43) Pub. Date: Feb. 23, 2017

(54) Multifunctional Wearable with Live Cam

(71) Applicant: Rainer Proksch, Altenriet (DE)

(72) Inventor: Rainer Proksch, Altenriet (DE)

(73) Assignee: MCONCEPTION EOOD, STARA ZAGORA (BG)

(21) Appl. No.: 14/833,049

(22) Filed: Aug. 22, 2015

(51) Int. Cl. G06F 1/16; G06F 3/02; G06F 3/0485; H04M 1/725; G06F 3/0488

(52) U.S. Cl. CPC G06F 1/163; H04M 1/7253; G06F 3/0488; G06F 3/0485; G06F 3/0219

(57) ABSTRACT

Multifunctional Wearable with Live Cam, a wearable electronic multipurpose device is disclosed. The device can function along with an electronic device or it can also function as a standalone device in some situations. The Multifunctional Wearable with Live Cam include a touch screen and a display, a camera lens, one or more speakers, a microphone, one or more LEDs and other electronic components necessary for the functioning. The wearable electronic device, when removably coupled together with an electronic device, such as a Smartphone, may transmit real time events or happenings, over the network, to a person at the other side. Other than transmitting real time live events, various other possibilities include. Other possibilities may include, as, an external power source for the connected mobile electronic device, a fitness tracking device. Other possibilities may also be considered.

### BACKGROUND OF THE INVENTION

Today mobile electronic devices have become so much popular that people have become very much attached to such devices and in particular to mobile phones. Now-a-days mobile phones have become an important part of an individual's life that these devices play a major role in one's personal, social and professional life.

Mobile phones are used for a variety of purposes now-a-days apart from making calls. People use mobile phones for listening music, playing games, taking photos and videos, chatting with friends and family, sending videos and a lot other functions. All these functions in today's phone have made things easier, in both the personal and professional life of an individual.

But in today's fast world people are multi functioning and they want to do more than one activity at a time. But most of the functions in the mobile phone require people to be engaged in it to use those functions. Some of them are taking photos and videos. If an additional device can be paired with the mobile phone or tablet, which can be worn on the clothes or placed somewhere, then the user can be hands free and he can participate in any activity simultaneously. Moreover if the device is configured to function independently in some situations, other than pairing with a mobile electronic device, then the user can at times use the device alone, easily without the hassle of pairing with the mobile electronic device. With such a configuration, the user is required to pair the device with a mobile electronic device for some specific functions only.

Other than this, if people are able to send real time live happenings to their friends, family or a business associate or customer, by pairing the mobile phone with an additional device, it will be an additional benefit to people in their personal, social and business life.

A small, lightweight device which can be worn on the clothes or belts or attached to appropriate mounts and placed on a surface, and coupled with an electronic device such as a mobile phone or tablet, and which can utilize some of the features of the mobile electronic device or function on its own, can be developed. If the user wishes to use the device alone, such possibility can also be considered. The device should be such that, it can share real time live events or happenings to a Smartphone or Tablet or any such device at the other end of the network. It should be possible to share information to one or more devices at one time.

Other than sharing real time live events, various other aspects can also be made available that enhances or extends the features and functions of a Smartphone. Other possibilities can also be considered where the device can function as a host device with a Smartphone as a peripheral device.

### BRIEF SUMMARY OF THE INVENTION

The invention is a wearable electronic device, Multifunctional Wearable with Live Cam, which can be worn in various ways such as, but not limited to, around the neck as a necklace, clipped on the clothes, or it can be mounted on appropriate mount and placed on appropriate surface. According to one embodiment, the Multifunctional Wearable with Live Cam can provide additional electrical circuitry or devices that can be used as such, or, which can be used along with an electronic device. The electronic device can be a mobile electronic device that can be paired together with the Multifunctional Wearable with Live Cam which provides additional electrical circuitry or devices. The mobile electronic device can be connected with the Multifunctional Wearable with Live Cam in a detachable manner. When paired with the Multifunctional Wearable with Live Cam, the electronic device can extend its efficiency, by using the additional electrical circuitry or devices implemented in the Multifunctional Wearable with Live Cam. In another embodiment, the electronic device can be essentially integrated with the Multi Headset Control which provides the additional circuitry or devices.

In addition to the above, other possibilities can also be considered where a Multifunctional Wearable with Live Cam can be configured such that it can function independently in certain situations using its own resources. In such an arrangement it may also be such that the Multifunctional Wearable with Live Cam can be the host with the Smartphone as a peripheral device.

The Multifunctional Wearable with Live Cam is a device which can be worn using appropriate clips or mounts or which can be placed independently on any surface using appropriate mounts or stands. The invention can include a rounded squared case that is configured to connect a mobile electronic device. The rounded squared case can include a touch screen display, control circuitry and a battery. The touch screen display can be configured to display information and to receive input from the user. The control circuitry can be configured to control the operations of the Multifunctional Wearable with Live Cam. The battery can be configured to provide power to the Multifunctional Wearable with Live Cam. As an additional function, the battery can be configured to function as an additional power source to the connected mobile electronic device. There can be a clip at the back side of the rounded squared case which can be used to clip the Multifunctional Wearable with Live Cam on clothes.

Different forms, features and advantages of the invention will be explained in the following detailed description which is described with the help of the accompanying drawings.

### BRIEF DESCRIPTION OF THE DRAWINGS

The invention can be explained using some drawings which are as following:

FIG. 1 is a perspective view of Multifunctional Wearable with Live Cam which is a wearable electronic device.

FIG. 2 is a simplified diagram of a communication network which shows how a Multifunctional Wearable with Live Cam paired with a Smartphone shares data over the network.

FIG. 3 is a block diagram of an environment which shows how the Multifunctional Wearable with Live Cam in conjunction with an electronic device such as a Smartphone is used for communication.

FIG. 4 is a block diagram of Multifunctional Wearable with Live Cam, which is a wearable electronic device.

FIG. 5 is a cross-sectional view of a Multifunctional Wearable with Live Cam according to one embodiment.

### DETAILED DESCRIPTION OF THE INVENTION

The invention Multifunctional Wearable with Live Cam is a wearable electronic device, which can be coupled with a mobile electronic device to augment the capabilities of the electronic device. For example, according to one embodiment, the Multifunctional Wearable with Live Cam when coupled with a mobile electronic device such as a Smartphone can share real time live events or happenings or any current occasions that the sender wishes to send concurrently over the network, to another mobile electronic device such as a Smartphone or a Tablet, at the other end of the network. The live real time events can be shared with one or more devices at the other end of the network. While sharing the real time live happening or events or anything that the user wishes to send, the center point of the cam or the media being transferred is fixed by any picture fixing technique. It can be a laser or any other such method which the user can switch on while starting the live streaming and switch off after it ends.

As such, Multifunctional Wearable with Live Cam is a device which can also be configured to function on its own. In short, different variations can be considered. In one representation, the Multifunctional Wearable with Live Cam can be connected with a mobile electronic device such as a Smartphone where the Multifunctional Wearable with Live Cam can function as a peripheral device for the connected Smartphone, or, the Multifunctional Wearable with Live Cam can be the Host where the Smartphone can be the peripheral device. In another variation, the Multifunctional Wearable with Live Cam can be made to function on its own in certain situations, where the Multifunctional Wearable with Live Cam functions using its own resources.

Apart from sharing real time live events, the Multifunctional Wearable with Live Cam, when coupled with a mobile electronic device can augment the capabilities of the mobile electronic device, by providing additional electrical circuitry or devices.

When coupled with the mobile electronic device, the Multifunctional Wearable with Live Cam can enhance the features of the mobile electronic device. For example, when the Multifunctional Wearable with Live Cam is coupled with the mobile electronic device, the user can use it as a music enhancer. In other words, the Multifunctional Wearable with Live Cam enhances the music to high quality digital music.

Additionally, the electronic device can utilize the electrical circuitry or devices in the Multifunctional Wearable with Live Cam to augment its capabilities. Advantageously, the Multifunctional Wearable with Live Cam can be configured to function as it is.

The Multifunctional Wearable with Live Cam is a device which can be worn using appropriate clips or mounts or which can be placed independently on any surface using appropriate stands or mounts.

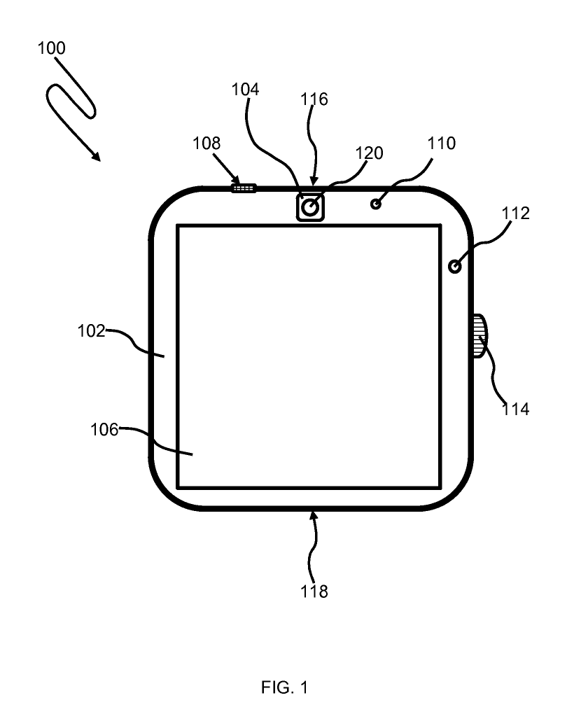

The representation and use of the invention are discussed with the help of figures, FIG. 1 to FIG. 5. The descriptions and figures given herein are for the explanatory purposes. However, it has to be mentioned that the invention can extend beyond these explanations.

FIG. 1 is a perspective view of a wearable electronic device, Multifunctional Wearable with Live Cam, 100 according to one embodiment. The electronic device 100 can be worn around the neck, clipped on the clothes, or mounted on a stand and placed on a surface. Other variations can also be considered. The device 100 can include a center portion 102, a top connection interface 116 and a bottom connection interface 118, both on the top and bottom portions of the center portion 102. The top connection interface 116 and the bottom connection interface 118 can be sockets for USB or headset. In one embodiment, the center portion 102 can be configured to receive a mobile electronic device. The center portion 102 can be configured to integrate a hood 104. The hood 104 can include a photosensitive device. The photosensitive device can be a lens 120 that receives real time live events or happenings that occurs in front of the lens. The Multifunctional Wearable with Live Cam 120 can be connected to the mobile electronic device via wired or wireless means. The centre portion 102 can also include a display 106. In one implementation, the display 106 is a touch screen display capable of receiving touch inputs from a user. The display 106 is also capable of displaying information to the user. In one embodiment, the center portion 102 has a native function as a portable media player and thus provides music play back from the connected mobile electronic device.

Additionally, the center portion also includes a knob 114 at the right side. It can be configured to make selections by a user.

The center portion 102 can further include an electrical component 112. The electrical component 112 can be configured to convert electric energy directly into light. The electrical component can be a Light Emitting Diode.

Still further, the central portion 102 of the wearable electronic device, Multifunctional Wearable with Live Cam, 100 can include one or more electrical components. The one or more electrical components in the central portion 102 can also be configured to connect to mobile electronic device via wired or wireless means. As example the one or more electrical components included in the central portion 102 can be one or more of a printed circuit substrate and a battery.

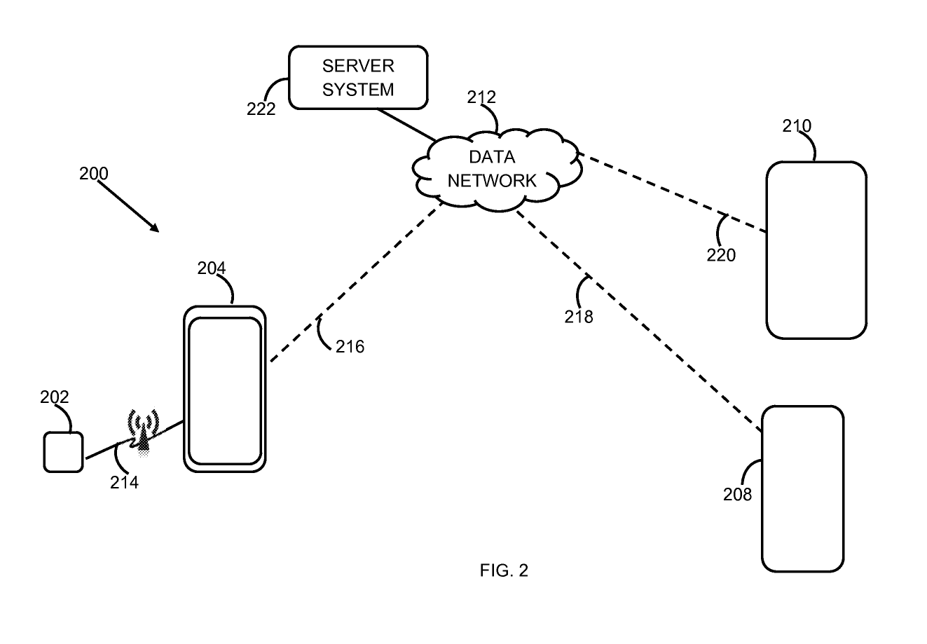

FIG. 2 illustrates a view of a network 200 in which a Multifunctional Wearable with Live Cam can be used along with a mobile electronic device to communicate over the network. As depicted, the network 200 includes a data network 212 connected to radio access networks 216, 218 and 220. The data network 212 can be one or more interconnected communication network such as or including the Internet. The radio access network 216, 218 and 220 can be any of a service provider's cellular network supporting such as for example 3G or 4G radio technologies.

The network 200 can also include a server system 222 connected to the data network 212. The server system 222 can be a website or any such network-based facility.

FIG. 2 also shows a Multifunctional Wearable with Live Cam 202 connected to a mobile electronic device which is a Smartphone 204 here. The Multifunctional Wearable with Live Cam 202 can be connected to the Smartphone 204 via wireless technology, which can be a Bluetooth connection for example. The Multifunctional Wearable with Live Cam 202 can also be connected to the Smartphone 204 via wired technology.

Further, FIG. 2 shows that the Smartphone 204 is connected to the data network via radio access network 216. The radio access network can be any of a service provider's cellular networks supporting such as 3G or 4G technologies. Here the Smartphone 204 can also be seen as an external 3G or 4G modem allowing the device to get connected to the cellular network. The data network 212 is connected to mobile electronic devices such as Smartphone 208 and Tablet 210 via radio access network 218 and 220. The radio access network can be any of a service provider's cellular networks supporting such as 3G or 4G technologies.

FIG. 2 illustrates one view of a network 200 in which a Multifunctional Wearable with Live Cam 202 coupled with a mobile electronic device, such as a Smartphone 204, can send real time live events over the network to any Smartphone or tablet. Here the real time live events shared by the Multifunctional Wearable with Live Cam 202 are sent to the Smartphone 204 via wireless network 214 which can be a Bluetooth network. The shared real time live events are then transmitted over the data network via radio access network 216. Then it is transmitted to the electronic devices at the other end of the network such as a Smartphone 208 and/or a Tablet 210. The real time live events are shared with the Smartphone 208 and/or Tablet 210 via radio access networks 218 and 220.

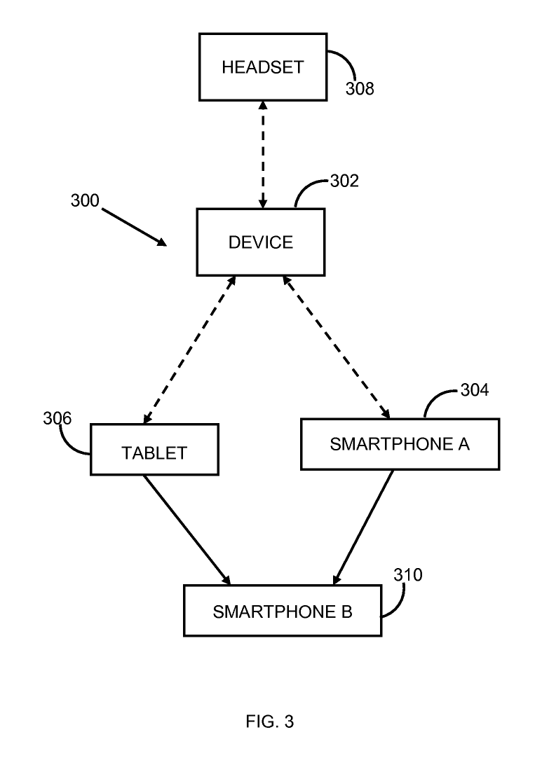

FIG. 3 is a block diagram that shows an environment 300, depicting the connection of the Multifunctional Wearable with Live Cam 302, with multiple electronic devices, and thereby, transfers data through the network. The environment 300 allows a user of multiple electronic devices to make use of Multifunctional Wearable with Live Cam 302, for certain output information and/or for certain input and for sharing real time live events across the network. The presence of the Multifunctional Wearable with Live Cam 302 in the environment 300 allows for efficient and convenient user interaction with one or more other electronic devices and thereby across the network. More particularly, as shown in FIG. 3, the environment 300 can enable the user of the Multifunctional Wearable with Live Cam 302 to interact with a mobile phone 304 or a Tablet 306, and a headset. The interaction with the Multifunctional Wearable with Live Cam 302 can be wired or wireless. That means the Multifunctional Wearable with Live Cam can support wired or wireless interaction with nearby electronic devices to which it is paired, such as a mobile phone 304 or a Tablet 306 and a Headset 308.

The environment 300 can be configured to support one or more information exchanges using a Multifunctional Wearable with Live Cam as discussed herein.

One data exchange facilitated by the environment 300 is real time live sharing of events or happenings or any current occasions that the sender wishes to send, that is initiated by the Multifunctional Wearable with Live Cam 302 to the nearby electronic device such as a Smartphone 304 or a Tablet 306 and then from the Smartphone 304 or Tablet 306, the data can be transmitted concurrently to other end across the network to electronic devices such a Smartphone 310. The data can be transmitted simultaneously to one or more electronic devices such as one or more Smartphones, one or more Tablets etc. While transmitting the real time live happenings or events or anything the user wishes to send, the midpoint of the cam or the media being sent is taken care of by any picture fixing technique such as a laser or any other such method.

In another embodiment the information exchange in the environment 300 can be a notification from one electronic device to a nearby connected Multifunctional Wearable with Live Cam, which in this case is Multifunctional Wearable with Live Cam 302. The Multifunctional Wearable with Live Cam 302 in this case, can receive information from the nearby electronic device such as a Mobile Phone 304 or a Tablet 306. For example, the Mobile phone 304 or the Tablet 306 receives a message or a call and it notifies the Mobile Headset Control Box 302. When the Multifunctional Wearable with Live Cam 302 receives the notification from the nearby electronic devices such as the Mobile Phone 304 or a Tablet 306, the Multifunctional Wearable with Live Cam 302 alert the user through an audio device, or the display device, or using the haptic device of the Multifunctional Wearable with Live Cam 302. Once notified the user can view the additional information connected with notification via the display device or hear the additional information connected with the notification via the audio device. If the user wishes to respond to the notification, the user can interact with either the Multifunctional Wearable with Live Cam 302 or directly to the electronic device Mobile Phone 304 or the Tablet 306. For example if the Mobile Headset Control Box alerts the user of an incoming phone call at the mobile phone 304, the user can accept or decline the phone call using the Multifunctional Wearable with Live Cam 302.

Thus any incoming information or data to a user's electronic device is transferred either wirelessly or through cable to the nearby Mobile Headset Control Box.

Other than information exchange, the Multifunctional Wearable with Live Cam can be used to provide remote user controls to a user. For example, the Multifunctional Wearable with Live Cam can be used to control or select the options in the electronic device (for example, Smartphone). For this, the Multifunctional Wearable with Live Cam can be configured with one or more user controls.

Besides, the Multifunctional Wearable with Live Cam can be used to transmit real time workout statistics to the user's electronic device (For example, a Smartphone). The statistics can be for example, but not limited to, heart rate of the user, run time values, Blood Pressure etc. To know the Blood Pressure readings the Multifunctional Wearable with Live Cam may have to be coupled with a wrist wearable device.

The Multifunctional Wearable with Live Cam can also be configured to receive alerts from the user's electronic device. The alerts can be for example but not limited to reminders, calendar alerts, weather alerts, and messages.

Besides alerts, the Multifunctional Wearable with Live Cam can accept user input that can be stored on the user's electronic device such as a Smartphone or displayed on the Multifunctional Wearable with Live Cam. With the user input, the Multifunctional Wearable with Live Cam can display for example, but not limited to Nameplate and social direct message.

With the user input, the Multifunctional Wearable with Live Cam can display for example, but not limited to social direct message, function as a Nameplate and many more. These are also direct messages face-to-face, means from person to person(s) directly.

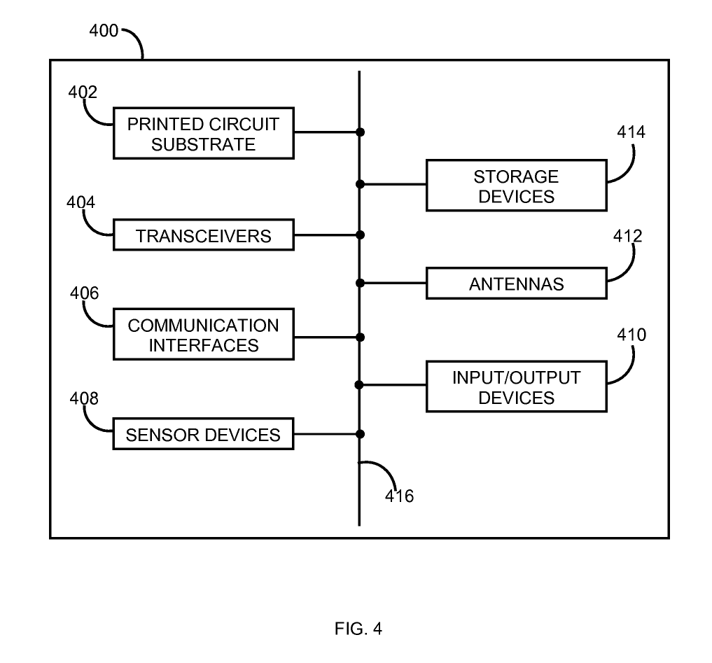

FIG. 4 is a block diagram depicting components that can be part of Multifunctional Wearable with Live Cam 400, which is a wearable electronic device in accordance with an example embodiment. As shown in FIG. 4, the wearable electronic device Multifunctional Wearable with Live Cam 400 can include one or more Printed Circuit Substrate 402, transceivers 404, communication interfaces 406, group of sensor devices 408, input/output devices 410, antennas 412, storage devices 414 and one or more electronic components 416 to which all the other components are coupled electrically.

The Printed Circuit Substrate can also include one or more electronic circuitry.

The transceivers 404 and communication interfaces 406 can be configured to support the communication between the Multifunctional Wearable with Live Cam 400 and other nearby electronic device paired with the Multifunctional Wearable with Live Cam 400. The nearby electronic device can be a Smartphone. One or more antennas and the transceiver together can help wireless communication possible between the Multifunctional Wearable with Live Cam 400 and the electronic device such as a Smartphone.

The input/output devices shown in FIG. 4 can include, but not limited to, Camera lens, Display which can be a Touch screen, Speaker, Microphone. The Camera Lens can be such that it can capture live happenings and share it live and in real time over the network to the other end. The device Multifunctional Wearable with Live Cam is equipped with a picture fixing technique that helps to fix the middle point of the cam or the media being transmitted, while sharing real time live happenings. This can be a laser that the user can switch on and off or any other picture fixing technique. The display can be for information display to the user, it can also include a touch screen that accepts user inputs. The Speaker and Microphone can function as an additional audio input and output device.

The Sensor Devices 408 can include, but not limited to Accelerometer, gyroscope, digital compass, proximity sensor and ambient light sensor.

The antennas 412 can include, but not limited to one or more Bluetooth antenna, GPS antenna, Wi-Fi antenna and so on. The storage devices 414 can be one or more volatile or non-volatile storage components.

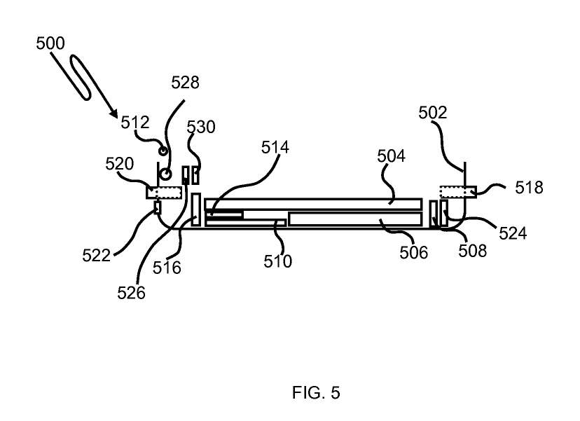

FIG. 5 is a cross-sectional side view of a Multifunctional Wearable with Live Cam 500 from one side. The Multifunctional Wearable with Live Cam includes a rounded squared case 502. The Multifunctional Wearable with Live Cam can accommodate all of the electrical components it requires. The electrical component can be one or more according to the requirement. The electrical component can be, for example, but not limited to, a display screen 504, which can be a touch screen, a printed circuit substrate 510 having electronic circuitry, a battery 506 and a vibration motor 508. Apart from this, the rounded squared case 502 can include a variety of other electronic components.

The rounded squared case can also include an antenna 516, which can be a Bluetooth antenna, near field antenna, or a GPS antenna. The antenna can be one or more Bluetooth antenna, or a group of one or more various varieties of such antennas. The rounded squared case can also include an audio socket 520, to connect an audio device. The rounded squared case can also include a socket 518 for connecting an electronic device using appropriate cables. The socket 518 can be a USB socket. The electronic device can be a mobile electronic device such as a Smartphone.

The rounded squared case can also include a speaker 512 for audio output. This can be much in use while using the Multifunctional Wearable with Live Cam as a standalone device. It also includes a flash card 514.

The rounded squared case of the Multifunctional Wearable with Live Cam can also include additional antennas 524. The additional antennas can be an additional Bluetooth antenna, additional GPS antenna or any other additional antennas as required. The rounded squared case can further include a microphone 522, an LED 526, camera 528 and a laser 530. The device can include more than one LED if necessary.

Besides, the Multifunctional Wearable with Live Cam can be used to transmit real time workout statistics to the user's electronic device (For example, a Smartphone). The statistics can be for example, but not limited to, heart rate of the user, run time values, Blood Pressure etc. To know the Blood Pressure readings the Multifunctional Wearable with Live Cam may have to be coupled with a wrist wearable device.

Multifunctional Wearable with Live Cam can accept user input that can be stored and/or displayed on the screen. With the input from the user, the Multifunctional Wearable with Live Cam can display for example, but not limited to, Nameplate and social direct message. These are also direct messages face-to-face, means from person to person(s) directly.

In the various features, functions and representations explained, the Multifunctional Wearable with Live Cam can enhance the efficiency of the mobile electronic device coupled with it. The mobile electronic device can be for example a Smartphone. For example, it can enhance the efficiency by providing additional display, audio, buttons, sensors, input options and other such components. It can also provide additional electronic components such as, but not limited to one or more sensors, GPS etc. The electronic components can also include electronic circuit, Printed Circuit Substrate, integrated circuit, micro processors etc.

When a Wi-Fi adaptor is used, the device could share the network, being in standalone mode.

In the features, functions and representations explained, the Multifunctional Wearable with Live Cam, includes a vibration motor. It can be any vibrator device that is capable of giving a haptic feedback or a vibration alert to the user. The vibrator device can be positioned in such a way that it is close to the body when worn, so that user can sense the vibration. When placed on a surface, the alert can be in the form of audio. Thus it is ensured that no alert is missed by the user.

Besides the discussed features, functions and uses of the invented device, the electrical and electronic components can also be configured for use as other forms such as an external power source for the coupled mobile electronic device, a fitness tracker and many other ways that go with the scope of the invention.

The different representations, features, configurations or aspects of the Multifunctional Wearable with Live Cam can be used separately or in combination.

The uses and advantages of the Multifunctional Wearable with Live Cam are numerous. One advantage is that it can share real time live events, when coupled with a mobile electronic device such as a Smartphone. When coupled with a mobile electronic device, the Multifunctional Wearable with Live Cam can enhance the features and functions of the mobile electronic device.

The Multifunctional Wearable with Live Cam can provide direct information to the user from the coupled mobile electronic device.

Apart from the discussed features, functions, representations or aspects there can be further representations, features, functions or aspects possible, of the Multifunctional Wearable with Live Cam. Further modifications and changes can be made, without limiting the invention to the discussed representations or functions. The modifications or changes can be accomplished meeting the scope of the invention.

1. A Multifunctional Wearable with Live Cam, which is a wearable electronic device, the main function of which is to share or transmit real time live events over the network. The device can be worn like a necklace, clipped on the clothes, belts, or which can be mounted on appropriate mounts and worn, or which can be mounted on appropriate stands or mounts and placed on a surface, comprising of a rounded squared case that includes on the outside:
a camera lens that captures or shares real time live events or happenings or any current occasion so as to transmit it live and in real time to a Smartphone or tablet at the other end of the network so that the person at the other end can view it live and in real time as it happens.
a touch screen display, for information display and to input information.
a microphone that helps in voice input
speaker that helps in output such as an audio output
LED that blinks indicating the functioning of the device and it also functions as alerts a button at the side configured for many functions
laser or any other technique that helps to fix the center point of the camera or the media being transferred.
a pair of sockets to connect a mobile electronic device such as a Smartphone, or to connect a headset a clip at the back of the device

2. The Multifunctional Wearable with Live Cam of claim 1 has the shape of a rounded square comprising of a back cover, a front cover which is parallel to the back cover, a circumferential wall in between the back cover and the front cover, perpendicular to the back cover and the front cover.

3. The camera lens of claim 1 captures or shares the real time live events or happenings or any current occasion that the user wishes to share over the network. It is shared simultaneously or in real time as it is happening over the network to a receiver at the other end of the network so that the person a the other end can view everything at the same time as it is happening. The receiver can be a Smartphone or a Tablet.

4. The touch screen of claim 1 is located on the front cover of the rounded squared housing and occupies the maximum space of the front cover. The touch screen accepts user inputs and also acts as a display. The touch screen accepts user input and also displays information to the user or to the public. The information can be a personal slogan or direct social message, smileys etc. The touch screen can also function as a nameplate. The information can also be for example date time or any information.

5. The microphone of claim 1 helps the user to speak to the person at the other end of the network while sharing real time live events or while on a normal phone call.

6. The speaker of claim 1 helps in audio output. The audio can be anything such as music, a call, or alert.

7. The LED of claim 1 blinks when the device is working. It notifies the working of the device. It is also provided for the safety of the user while on the road.

8. The button of claim 1 called the Multi Button has multiple purposes. It is used for switching the Multifunctional Wearable with Live Cam on and off. One other function of the Multi Button is zooming while live sharing of events, real-time live streaming or video calling. One other function of the Multi Button is to scroll through the options displayed on the touch screen.

9. The laser or any other technique in claim 1 fixed the middle of the cam or the media being transferred, while sharing real time live events. While starting real-time live streaming, the user can switch on the laser or the other method used, which will fix the middle of the live stream you want to send.

10. The pair of sockets of claim 1 is configured to connect a Smartphone and a headset to the Multifunctional Wearable with Live Cam.

11. The clip of claim 1 is used to secure the device tightly on to the clothes or belts. Other than clipping the device, the device can also be mounted on appropriate mounts and worn. It can also be mounted on appropriate stands and placed on a leveled surface. It can also be worn around the neck as a necklace.

12. The Multifunctional Wearable with Live Cam of claim 1 can also function as a fitness tracker. It can be the heart rate of the user, run time values, blood pressure etc.
